(19) United States
(12) Patent Application Publication
(10) Pub. No.: US 2018/0174185 A1
(43) Pub. Date: Jun. 21, 2018

(54) SYSTEMS, DEVICES, AND METHODS FOR LINKING ONLINE BEHAVIOR TO OFFLINE PAYMENT TRANSACTIONS

(71) Applicant: MONERIS SOLUTIONS CORPORATION, Toronto (CA)

(72) Inventor: Sanjeev CHIB, Toronto (CA)

(21) Appl. No.: 15/736,717

(22) PCT Filed: Jul. 3, 2015
(86) PCT No.: PCT/CA2015/000426

§ 371 Date: Dec. 14, 2017

(51) Int. Cl. G06Q 30/02; G06Q 20/32

(52) U.S. Cl. CPC G06Q 30/0255; G06Q 20/325; G06Q 30/0277

(57) ABSTRACT

Systems, methods, and devices for linking a consumer's online behavior to an offline payment transaction are disclosed. A first mapping between an identifier of the consumer and an identifier of a payment card of the consumer is generated. A second mapping between the identifier of the consumer and an identifier of an online behavior of the consumer is generated, in association with visiting a webpage. Data reflective of an offline payment transaction is received, the data comprising the identifier of the payment card. A link between the online behavior and the offline transaction is identified by processing the generated first mapping, the generated second mapping, and the received data.

### FIELD

This disclosure relates to tracking consumer behavior, and more particularly, relates to linking consumers' online behavior to their offline payment transactions.

### BACKGROUND

Various ways to track consumers' online behavior (e.g., exposure to online advertising, online payment transactions, etc.) are known. Various ways to track consumers' offline payment transactions are also known.

The consumer intelligence that may be gained from separately tracking a given consumer's online behavior and that consumer's offline payment transactions is limited.

Accordingly, there is a need for improved tracking methods, systems, and devices, or at least alternatives.

### SUMMARY

In an aspect, there is provided a computer-implemented method for linking a consumer's online behavior to an offline payment transaction. The method includes: at, at least one processor: generating a first mapping between an identifier of the consumer and an identifier of a payment card of the consumer; generating a second mapping between the identifier of the consumer and an identifier of an online behavior of the consumer, in association with visiting a webpage; receiving data reflective of an offline payment transaction, the data comprising the identifier of the payment card; and identifying a link between the online behavior and the offline transaction by processing the generated first mapping, the generated second mapping, and the received data.

In another aspect, there is provided a computer system for linking a consumer's online behavior to an offline payment transaction. The system includes: at least one processor; and memory storing instructions, that when executed at the at least one processor, cause the system to: generate a first mapping between an identifier of the consumer and an identifier of a payment card of the consumer; generate a second mapping between the identifier of the consumer and an identifier of an online behavior of the consumer, in association with visiting a webpage; receive data reflective of an offline payment transaction, the data comprising the identifier of the payment card; and identify a link between the online behavior and the offline transaction by processing the generated first mapping, the generated second mapping, and the received data.

Many further features and combinations thereof concerning embodiments described herein will appear to those skilled in the art following a reading of the instant disclosure.

### BRIEF DESCRIPTION OF THE FIGURES

In the figures,

FIG. 1 is a network diagram showing a network interconnecting a linking server, a partner server, a plurality of consumer devices, and a plurality of data sources, according to an embodiment;

FIG. 2 is a high-level block diagram of hardware components of the linking server of FIG. 1, according to an embodiment;

FIG. 3 is a high-level block diagram of software components of the linking server of FIG. 1, according to an embodiment;

FIG. 4 schematically illustrates linking of users and payment cards, according to an embodiment;

FIG. 5 schematically illustrates linking of users and offline payment transactions, according to an embodiment;

FIG. 6A, FIG. 6B, and FIG. 6C each schematically illustrates data flow for linking of users and offline payment transactions, according to an embodiment;

FIG. 7 schematically illustrates linking of users and offline payment transactions in relation to measuring advertising effectiveness, according to an embodiment; and

FIG. 8 schematically illustrates data flow for linking of users and offline payment transactions in relation to measuring advertising effectiveness, according to an embodiment.

### DETAILED DESCRIPTION

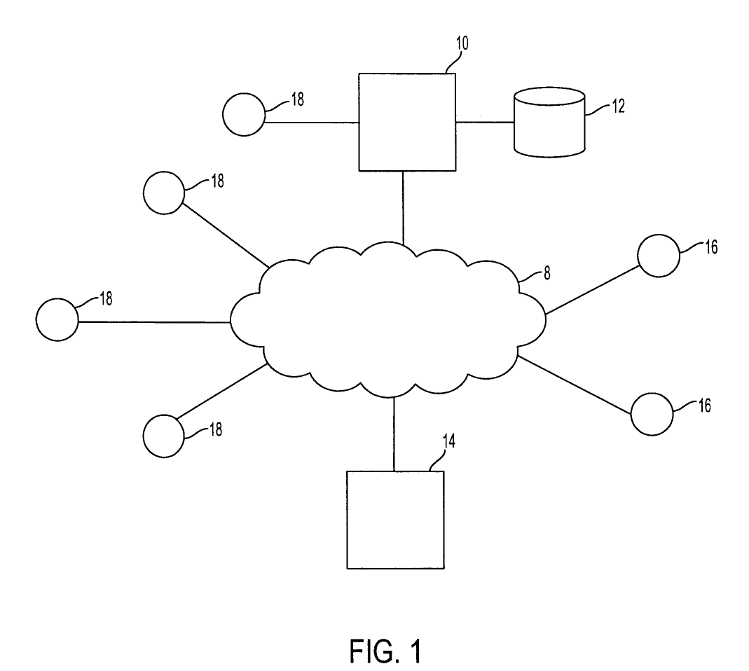

FIG. 1 illustrates a network 8 interconnecting a linking server 10, a partner server 14, a plurality of consumer devices 16, and a plurality of data sources 18, according to an embodiment. As will be detailed herein, linking server 10 is configured to generate data records reflective of links between online behavior of a plurality of consumers and their offline payment transactions.

In an embodiment, linking server 10 may be operated by a payment processor, and may be configured to process online payment transactions in known manners. In one example, linking server 10 may provide one or more payment processing Application Programming Interfaces (APIs) and/or one or more Hosted Payment Pages (HPP) in known manners, which may be used by merchant partners to process online payment transactions.

Linking server 10 is connected to and interoperates with partner server 14 in manners detailed herein. Partner server 14 may be operated by a partner (or client) of the operator of linking server 10. Such a partner may, for example, be a merchant, an operator of a Demand-Side Platform, an operator of an ad exchange platform, or the like. For clarity of illustration, only one partner server 14 is shown. However, there may be a plurality of partner servers 14, e.g., each operated by a different partner.

Linking server 10 is interconnected with a plurality of consumer devices 16, each of which may be operated by a consumer. Each consumer device 16 may be any networked computing device capable of accessing web content. For example, a consumer device 16 may be a personal computer, a workstation, a server, a portable computer, a mobile device, a laptop computer, or the like.

Linking server 10 is interconnected with a plurality of data sources 18. Linking server 10 may be connected to a data source 18 by way of network 8. Linking server 10 may also be connected to a data source 18 directly (e.g., by way of a port or a wired link). Data sources 18 are configured to maintain data reflective of offline transactions conducted by consumers. Accordingly, data sources 18 include storage media suitable for storing such data. Data sources 18 may also be configured with network interfaces suitable for transmitting the data reflective of offline transactions to linking server 10, e.g., by way of network 8.

Network 8 may be any network capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Linking server 10 may be connected to an electronic datastore 12. Datastore 12 is configured to store data received at or generated by linking server 10. For example, datastore 12 may store data reflective of offline transactions, e.g., as received from data sources 18. Datastore 12 may also store various tables including identifiers and mappings, e.g., of users, their online transactions, payment cards, partners, advertising campaigns, etc., as detailed below.

Datastore 12 may include a conventional relational database such as a MySQL™′ Microsoft™ SQL, Oracle™ database, or the like. Datastore 12 may also include another type of database such as, for example, an objected-oriented database or a NoSQL database. Accordingly, linking server 10 may include a conventional database engine (not shown) for accessing datastore 12, e.g., using queries formulated using a conventional query language such as SQL, OQL, or the like.

In an embodiment, linking server 10 may be configured to exchange (e.g., transmit and/or receive) web content (e.g., user identifiers, pixel tags, etc.) with one or more partner servers 14, or one or more consumer devices 16. In this embodiment, linking server 10 may include a conventional HTTP server application (e.g., Apache HTTP Server, nginx, Microsoft IIS, or the like) adapting linking server 10 to exchange such web content.

Linking server 10 may be embodied in any networked computing device, such as a personal computer, workstation, server, portable computer, mobile device, laptop computer, or the like. In an embodiment, linking server 10 may be implemented as a physical or virtual instance using various distributed-resource technologies, such as “cloud computing”. Potential benefits to “cloud computing” include ease of adding/removing resources, load balancing, etc.

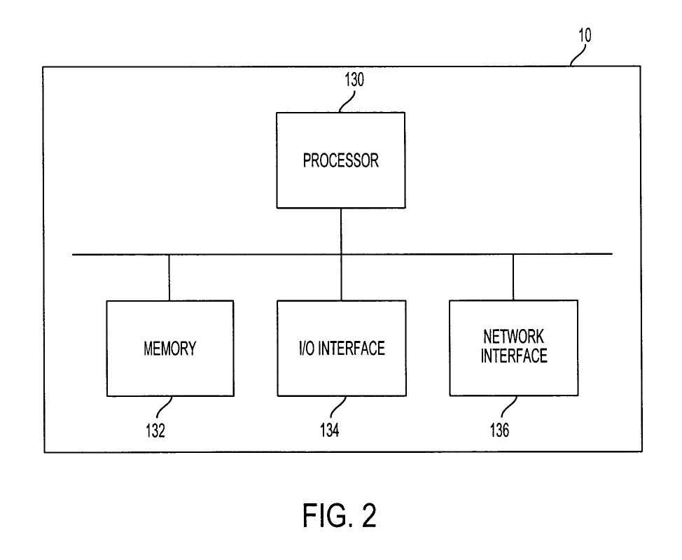

FIG. 2 is a block diagram depicting hardware components of linking server 10, according to an embodiment. As illustrated, linking server 10 includes at least one processor 130, memory 132, at least one I/O interface 134, and at least one network interface 136.

Each processor 130 may be any type of processor, such as, for example, any type of general-purpose microprocessor or microcontroller, a digital signal processing (DSP) processor, an integrated circuit, a field programmable gate array (FPGA), a reconfigurable processor, or any combination thereof.

Memory 132 may be any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. In an embodiment, datastore 12 may reside in memory 132.

Each I/O interface 134 enables linking server 10 to communicate with input and output devices, e.g., peripheral devices or external storage devices. Such peripheral devices may include one or more input devices, such as a keyboard, mouse, camera, touch screen and a microphone, and may also include one or more output devices such as a display screen and a speaker. In an embodiment, an I/O interface 134 may function as a data communication interface allowing linking server 10 to receive data, e.g., from a data source 18.

Each network interface 136 enables linking server 10 to communicate with other components (e.g., one or more partner servers 14 and/or data sources 18) to send data to and/or receive data from such other components, and to access and connect to network resources by way of a network or networks (e.g., network 8).

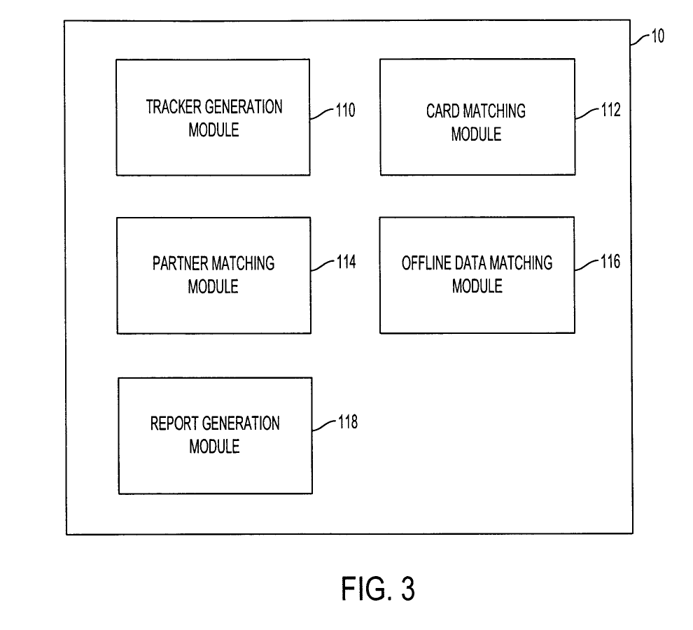

FIG. 3 illustrates various application modules that may be executed at linking server 10 to adapt it to function in manners disclosed herein. As shown, these modules include tracker generation module 110, card matching module 112, partner matching module 114, offline data matching module 116, and report generation module 118.

Each of these modules may be implemented in a high-level programming language, e.g., a procedural language, an object-oriented language, a scripting language, or any combination thereof. For example, each of these modules may be implemented using C, C++, C#, Perl, Java, JavaScript, or the like. Each of these modules may also be implemented in assembly or machine language. Each of the modules may be in the form of an executable program, a script, a statically linkable library, or a dynamically linkable library.

Tracker generation module 110 is configured to generate one or more tracking elements for tracking online behaviors of consumers.

Tracker generation module 110 generates a unique identifier for each consumer device to be tracked (e.g., each consumer device 16), which may be referred to herein as a “PayID”. The PayID may be generated in any conventional manner, and may, for example, be a numeric identifier, an alphanumeric identifier, or the like.

Tracker generation module 110 may provide a PayID to card matching module 112 or partner matching module 114 for the purpose of creating a cookie on a consumer's browser that includes the PayID, when the consumer visits a webpage hosted at linking server 10 (e.g., a Hosted Payment Page) or hosted at a third-party server (which may be a partner server 14). In some embodiments, tracker generation module 110 may provide a PayID to a third-party server (which may be a partner server 14) for the purpose of creating a cookie on a consumer's browser that includes the PayID, when the consumer visits a webpage hosted at that third-party server.

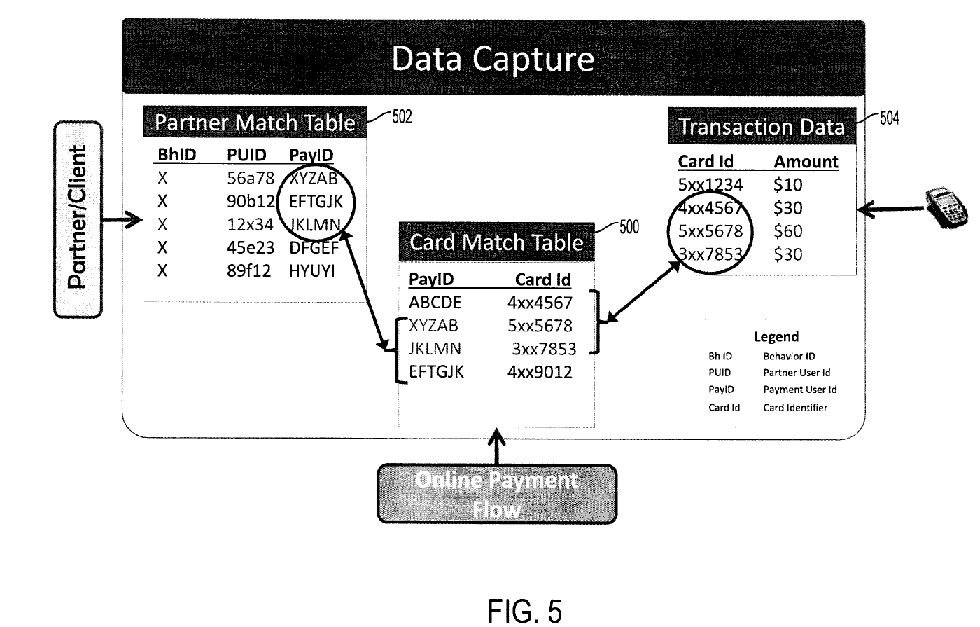

Card matching module 112 is configured to generate mappings between consumers and their payment cards. In particular, card matching module 112 generates Card Match Table 500 (FIG. 5) that stores mappings, each mapping between an identifier of a particular consumer (i.e., a PayID) and a unique identifier of a payment card used by that consumer (i.e., a Card ID). Card Match Table 500 may be stored, for example, in datastore 12 (FIG. 1).

Card matching module 112 is configured to generate such mappings in a variety of ways. Two such ways are detailed below, by way of example: (i) when a third-party server (e.g., operating as a merchant website) utilizes a Hosted Payment Page provided at linking server 10; and (ii) when a third-party server (e.g., operating as a merchant website) utilizes a payment Application Programming Interface provided at linking server 10.

In the Hosted Payment Page example, when the Hosted Payment Page is loaded by a consumer operating a consumer device 16, card matching module 112 reads the PayID from a cookie stored in the consumer's browser, or, if no cookie exists, card matching module 112 invokes tracker generation module 110 to generate a new PayID for the consumer, and a cookie with the PayID is stored on the consumer's browser (assuming that cookies are enabled).

A hidden field tag is included on the Hosted Payment Page, and may contain the value of the PayID. When a payment form is submitted, the Card ID that the consumer has entered and the PayID in the hidden field tag is passed to card matching module 112.

Subsequently, the card matching module 112 stores both the PayID and the payment card information that the consumer inputted on the Hosted Payment Page (the “Card ID”) in Card Match Table 500.

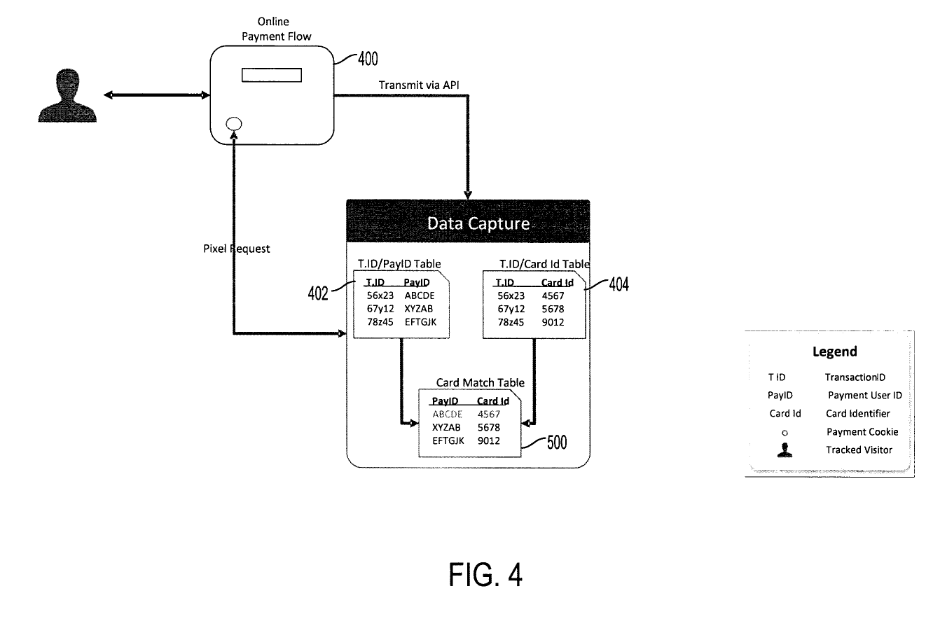

In the Application Programming Interface example: as illustrated in FIG. 4, a pixel tag is served on a webpage 400 in the payment flow (e.g., by a third-party server). When this webpage is accessed by a consumer using a consumer device 16, the pixel tag generates a request to linking server 10 along with other pertinent information, as detailed below. In the depicted embodiment, the pixel tag is image-based and requests a 1×1 pixel-sized image. This image may be invisible to the user (e.g., transparent or hidden from view). In other embodiments, a JavaScript-based pixel tag may be used. In yet other embodiments, other types of tags may be used.

When a consumer operating a consumer device 16 loads the webpage 400 with the pixel tag, a unique identifier of a particular online transaction (i.e., a Transaction ID or “T.ID”) is generated and the pixel tag sends a request to card matching module 112 along with the T.ID.

In one example, the pixel tag may be of the following form:

<img src=“https://something.payment_processor.com/PP_match?TID=<unique transaction id>/>

So, in this example, the pixel tag includes a URL of linking server 10, and a parameter T.ID. that is passed to card matching module 112. Other parameters may also be included in the pixel tag and passed to card matching module 112.

When card matching module 112 receives the pixel request, card matching module 112 generates (or reads) the PayID, and stores the T.ID and PayID in a table 402 (e.g., in datastore 12) for matching purposes, and responds with a 1×1 pixel-sized image. If it was necessary to create a new PayID for the consumer (e.g., by invoking tracker generation module 110), then the PayID is stored as a cookie in the consumer's browser.

When a payment page form is submitted by the consumer, the Card ID and the T.ID are transmitted to card matching module 112 through the Application Programming Interface, and stored in a separate table 404 (e.g., in datastore 12).

On a periodic basis, card matching module 112 runs a process that links the T.ID in tables 402 and 404, and thereby creates a mapping between a particular consumer's PayID and Card ID. If a particular PayID and Card ID mapping does not already exist in Card Match Table 500, card matching module 112 creates a new record in Card Match Table 500 to store that mapping.

In an embodiment, as an alternative to using cookies, device fingerprinting may be utilized to create a unique PayID for each consumer's device 16 that needs to be tracked. The device fingerprinting may, for example, be based on the device's media access control (MAC) address, the particular operating system (and version) executing at the device, the particular browser (and version) executing at the device, or the like, including a combination thereof. Such information for generating a device fingerprint may be collected in known manners.

The PayID generated using device fingerprinting may be stored in Card Match Table 500 and Partner Match Table 502.

Partner matching module 114 is configured to generate mappings between consumers and their online behaviors. In particular, partner matching module 114 generates Partner Match Table 502 (FIG. 5) that stores mappings, each mapping including an identifier of a particular consumer assigned by linking server 10 (i.e., a PayID), a unique identifier of that consumer assigned by a partner (i.e., a partner's unique user/consumer ID or “PUID”), and an identifier of a particular online behavior engaged in by the particular consumer (a behavior ID or “BhID”). The mapping may also include the name of the partner.

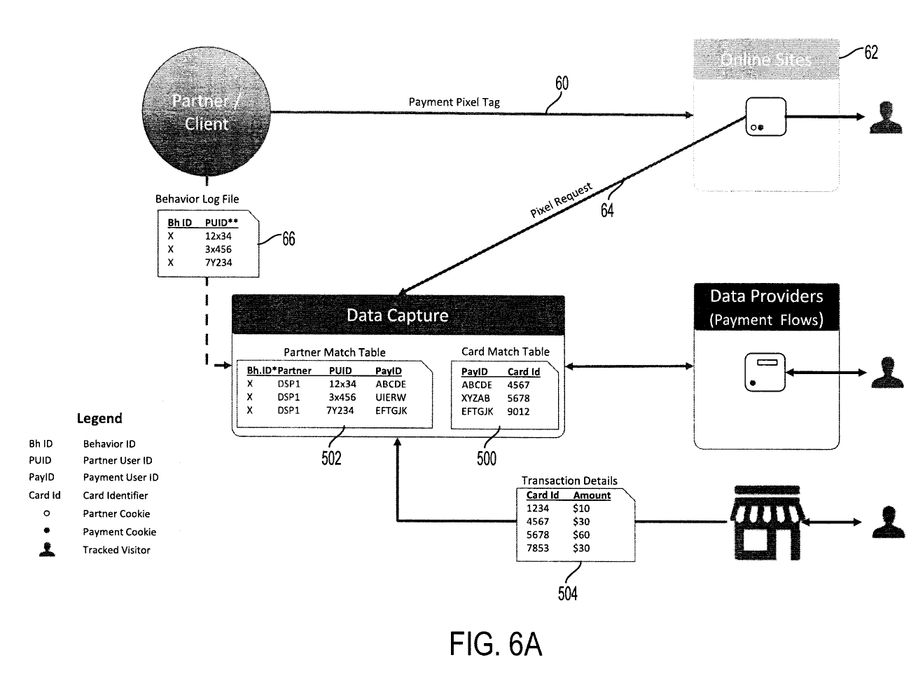

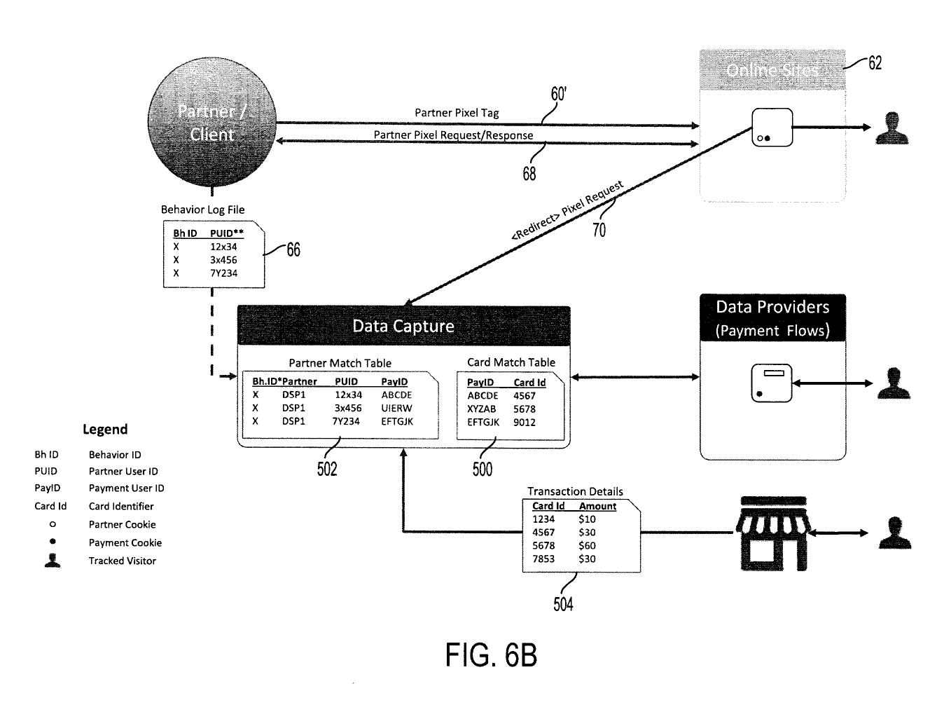

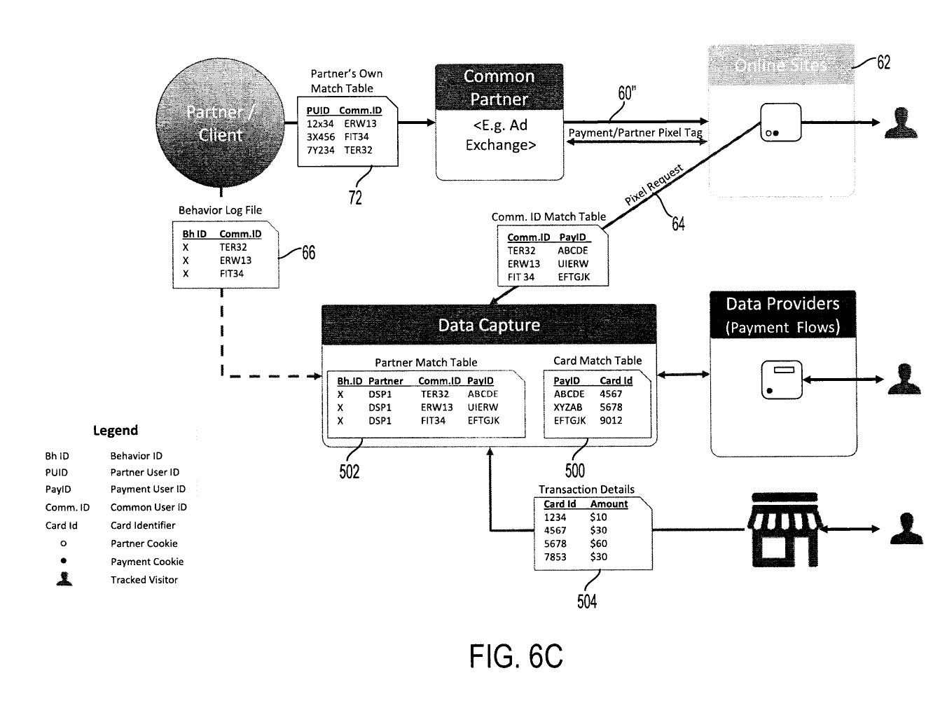

As shown in FIG. 6A, a pixel tag 60 is provided to a third-party server (which may be a partner server 14). This pixel tag 60 is served by the third-party server to consumers operating consumer devices 16 on relevant online page(s) 62 where consumers engage in various online behaviors, e.g., viewing an advertisement; watching a video; reading an article; playing a game; performing online searches; researching, purchasing, or browsing for products/services; communicating through online services (e.g., instant messaging services), or the like.

In one example, pixel tag 60 may be of the following form:

<img src=“https://something.payment_processor.com/pixel?p=<partner>&puid=<partner's consumer id>&BhID=<Behavior Id>/>

So, in this example, pixel tag 60 includes a URL of linking server 10, a parameter P (partner name), a parameter PUID, and a parameter BhID that is passed to partner matching module 114 by way of a pixel request 64. Other parameters may also be included in pixel tag 60 and passed to partner matching module 114.

In an embodiment, a partner may elect to omit the parameter PUID, to avoid generating the PUID. In this case, the partner may utilize pixel tag 60 in the manners described above without inserting a value for the parameter PUID. In this circumstance, partner matching module 114 will assume that every request received from that partner relates to the behavior being tracked and will use a NIL value for PUID.

In an embodiment, pixel request 64 may omit the parameter BhID. In this embodiment, partner matching module 114 may instead receive BhID information by way of a behavior log file 66 from a partner (e.g., the partner that generated the PUID noted above). For example, behavior log file 66 may be received from a partner server 14 operated by that partner. Behavior log file 66 includes a mapping of BhIDs and PUIDs, as logged by the partner.

Upon receipt of behavior log file 66, partner matching module 114 processes the behavior log file 66 to populate Partner Match Table 502 with mappings of BhIDs and PUIDs. Optionally, in this embodiment, partner matching module 114 may use two tables in place of Partner Match Table 502, namely, one table for storing a mapping of BhIDs and PUIDs, and a separate table for storing a mapping of PUIDs and PayIDs.

Conveniently, in this embodiment, it is not necessary to serve a pixel tag 60 in association with each behavior. Instead, a pixel tag 60 may be served at a first instance, or periodically.

As will be appreciated, the third-party server referred to in association with partner matching module 114 may be different from the third-party server referred to in association with card matching module 112.

As noted, when a particular consumer visits a webpage 62 with pixel tag 60, a pixel request 64 is sent to partner matching module 114.

The partner matching module 114 receives the pixel request 64. In response, the following operations by partner matching module 114 are possible:
Operation A. If it is a new consumer (i.e., no linking server 10 cookie exists):
   1. Invoke tracker generation module 110 to generate a new unique PayID.
   2. Create a linking server 10 cookie (with PayID stored) on the consumer's browser.
   3. Store the following in the Partner Match Table 502: Partner name (P), PayID, PUID, BhID (if BhID is received in pixel request 64), and any other information related to that partner (e.g. date and time stamp of request).
   4. Respond back with a 1×1 pixel-sized image (or redirect to a partner server 14).
Operation B. If it is an existing consumer (i.e., a linking server 10 cookie exists in the consumer's browser):
   1. Read linking server 10 cookie to obtain the PayID stored in the cookie.
   2. Search Partner Match Table 502 to determine if there already is a PUID and PayID match.
   3. If no match exists then:
      Store the following in Partner Match Table 502: Partner name (P), PayID, PUID, BhID (if BhID is received in pixel request 64), and any other information related to that partner (e.g. date and time stamp of request).
      Respond back with a 1×1 pixel-sized image (or redirect to a partner server 14).
   4. Else if a match exists then:
      Store the following in Partner Match Table 502: Partner name (P), PayID, PUID, BhID (if BhID is received in pixel request 64), and any other information related to that partner (e.g. date and time stamp of request). As will be appreciated, it may be desirable to store a separate record for the same behavior match as this allows the number of times the behavior occurred (e.g., an ad is viewed) to be determined.
      Respond back with a 1×1 pixel-sized image (or redirect to a partner server 14).

As shown in FIG. 6B, in an embodiment, pixel tag 60 may be replaced by a partner pixel tag 60′. In particular, this embodiment avoids any requirement for a third-party server (which may be a partner server 14) to directly serve a pixel tag associated with linking server 10 on webpage(s) 62. Instead, the third-party server (which may be a partner server 14) may serve a pixel tag 60′ associated with a partner server 14 on webpage(s) 62, and subsequently redirect the webpage(s) 62 to send a request to linking server 10.

In one example, partner pixel tag 60′ may be of the following form:

<img src=https://something.partner.com/pixel?partner=<partner id>/>

So, in this example, pixel tag 60′ includes a URL of a partner server 14, and a parameter partner id that identifies the entity to which a redirection should be provided (e.g., the operation of linking server 10). When pixel tag 60′ loads on the consumer's browser at a consumer device 16, the browser sends a request to a partner server 14 using the above URL (along with the parameter partner id). The partner server 14 then generates/reads its PUID for that consumer, and stores the PUID in a cookie on the consumer's browser. Then, the partner server 14 provides a response 68 back to the consumer's browser with a redirect pixel request (rather than a 1×1 pixel-sized image).

The response 68 to the consumer's browser is configured to redirect the consumer's browser to linking server 10 to initiate a pixel request 70.

In one example, the pixel request 70 may be made using a URL of the following form:

https://something.payment_processor.com/pixel?p=<partner>&puid=<partner's consumer id>&BhID=<Behavior Id>

So, in similar manner to pixel request 64, re-directed pixel request 70 includes a URL of linking server 10, a parameter P (partner name), a parameter PUID, and a parameter BhID that is passed to partner matching module 114. Upon receiving re-directed pixel request 70, partner matching module 114 may perform Operation A or Operation B, as described above.

In an embodiment, re-direct pixel request 70 may omit the behavior ID (BhID). Partner matching module 114 may generate a mapping of BhIDs and PUIDs using a behavior log file 66, in manners described above.

As shown in FIG. 6C, in an embodiment, an identifier of a particular consumer common to multiple partners (i.e., a “Common ID”) may be used in place of a PUID. For example, a Common ID may be an identifier from an ad exchange such as DoubleClick by Google, the Facebook Exchange, or the like.

In this embodiment, operation of partner matching module 114 is substantially the same as described above in association with a PUID, with the following differences.

As shown, pixel tag 60 may be replaced by a pixel tag 60″. In one example, pixel tag 60″ may be of the following form:

<img src=“https://something.payment_processor.com/pixel?p=<partner>&commonID=<common partner's consumer id>/>

So, in this example, pixel tag 60” includes a Common ID instead of a PUID. As will be appreciated, the form of the Common ID may vary, e.g., depending on the particular ad exchange involved. This Common ID is passed to partner matching module 114 by way of a pixel request 64. Pixel tag 60″ also includes the parameter P (partner name).

Partner matching module 114 records the parameters P, PayID, and Common ID and any other pertinent information in Partner Match Table 502.

Pixel tag 60″ omits the BhID. Partner matching module 114 may generate a mapping of BhIDs and Common IDs using a behavior log file 66, in manners described above. As shown, the partner may maintain a match table 72 including mappings of PUIDs and Common IDs, which may be used by the partner to generate the behavior log file 66.

In an embodiment, a pixel tag 60″ may be replaced by a common partner pixel tag (not shown). This common partner pixel tag may include a URL of a common partner server, which may be configured to re-redirect a pixel request to linking server 10, in manners described above.

Offline data matching module 116 is configured to generate mappings between consumers' online behavior and their offline payment transactions. In particular, offline data matching module 116 generates such mappings using Card Match Table 500 and Partner Match Table 502, and offline transaction data received from one or more data sources 18.

The offline transaction data may be stored in Transaction Data Table 504 and may include a consumer's Card Id, purchase amounts, and other pertinent information.

FIG. 5 illustrates example mappings generated by offline data matching module 116. For example, as shown, a consumer having PayID XYZAB may be mapped to a Card ID 5xx5678 in Card Match Table 500 (e.g., as mapped by card matching module 112). The same consumer may be matched to a particular online behavior “X”, as shown in Partner Match Table 502 (e.g., as mapped by partner matching module 114). For example, the particular online behavior may correspond to visiting a particular webpage, as represented by a particular BhID in Partner Match Table 502. The same consumer may also be matched to a particular offline transaction (in amount of $60), as shown in Transaction Data Table 504 based on the consumer's associated Card ID. In this way, the consumer's online behavior is mapped to his/her offline transaction.

In a specific embodiment, linking server 10 may be configured to facilitate measurement of advertising effectiveness. In this embodiment, the particular online behavior of interest is viewing of ads from particular advertisement campaigns, e.g., as facilitated by particular ad exchanges.

In this embodiment, partner matching module 114 is configured to generate mappings between consumers and particular advertising campaigns viewed by those consumers. So, partner matching module 114 is configured to use an Ad Campaign ID (Ad.ID) in place of a Behavior ID (BhID). In another embodiment, an Ad ID uniquely identifying a particular ad, or an Ad ID uniquely identifying a particular ad served by a particular partner, may be used in place of an Ad Campaign ID to provide greater tracking granularity.

Accordingly, a pixel tag of the following form may be used, to provide partner matching module 114 with an Ad Campaign ID and a PUID to permit a match therebetween:

<img src=“https://something.payment_processor.com/pixel?p=<partner>&puid=<partner's consumer id>&AdID=<Ad Campaign Id>/>

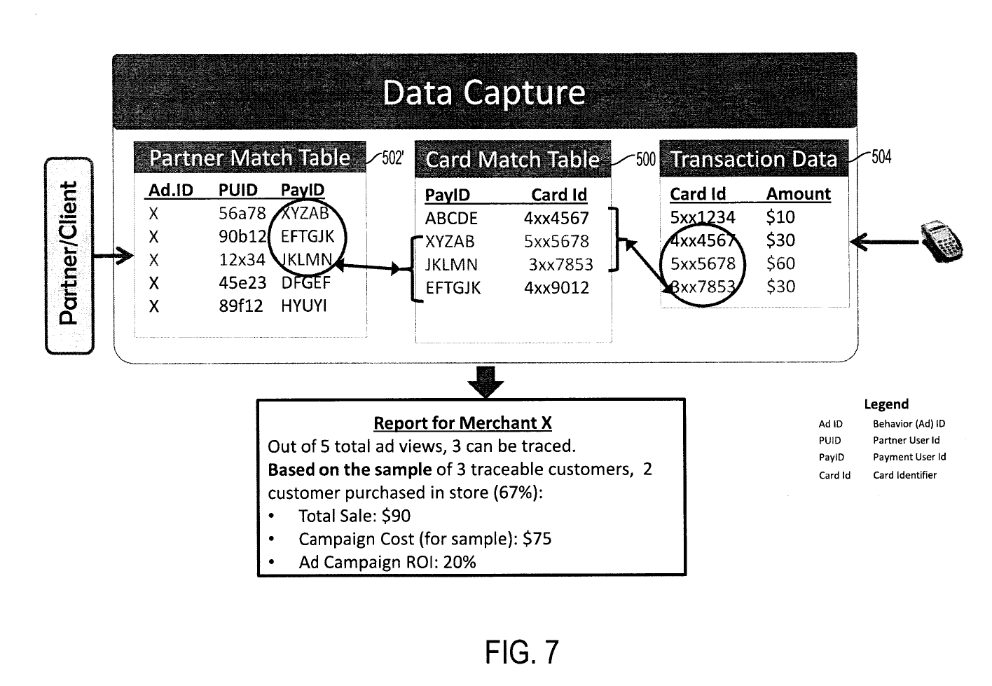

Further, Partner Match Table 502 may be replaced by Partner Match Table 502′ configured to store an Ad.ID instead of a BhID, as shown in FIG. 7.

In an embodiment, where a partner (e.g., a Demand-Side Platform) cannot serve a pixel tag directly, but is able to maintain a match table with an ad exchange (e.g., with Google's DoubleClick Ad Exchange), the partner may provide offline data matching module 116 with data containing the Ad.ID and corresponding Common ID. Using the Common ID, offline data matching module 116 determines the associated PayID in Partner Match Table 502/502′, and then for each of the records, matches it to the Card ID in Card Match Table 500.

Once the corresponding Card IDs for a particular ad campaign that is being tracked are known, these Card IDs can be matched to the offline (e.g., in-store, over-the-phone, in-app, or the like) payment transaction data, e.g., of the same merchant as participating in the ad campaign.

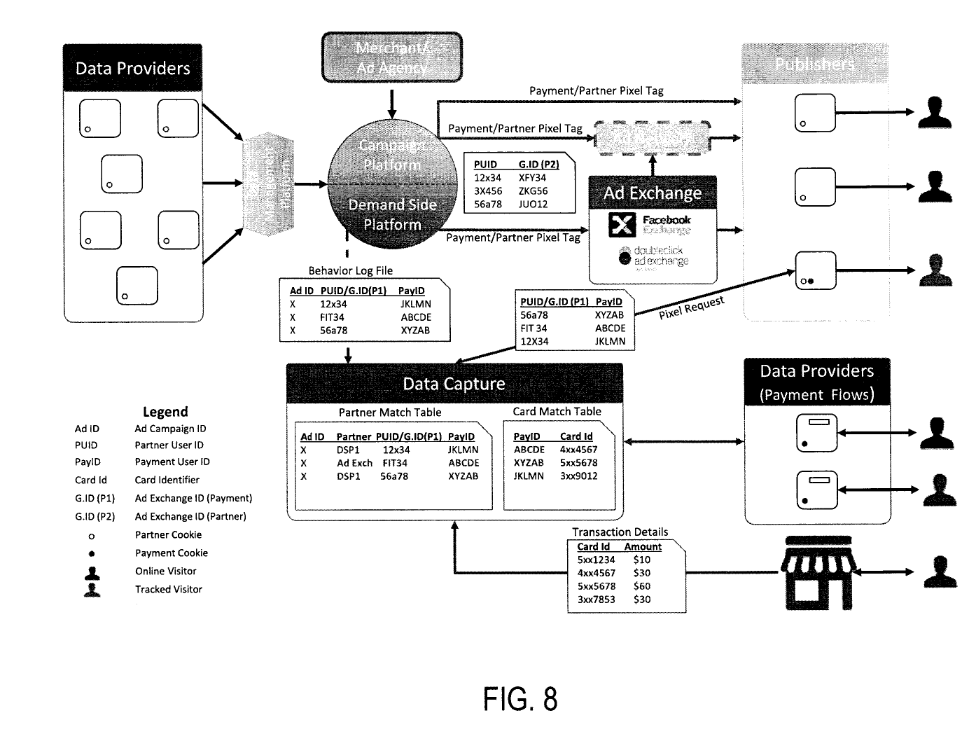

FIG. 8 schematically illustrates the operation of linking server 10 in relation to measuring advertising effectiveness, as described above.

As shown, various entities (e.g., merchants/ad agencies, data providers, Campaign Platform/Demand-side Platform operators, ad exchanges) may interoperate in known manners to implement advertising campaigns. Operation of linking server 10 is substantially similar to that described with reference to FIG. 6C for embodiments using a Common ID.

As will be appreciated, a particular ad exchange may employ multiple Common IDs for a particular consumer. For example, as shown in FIG. 8, an ad exchange may use two different Common IDs for a particular consumer, i.e. G.ID(P1) and a G.ID(P2). In this case, a specific one of the Common IDs may be selected for use in association with linking server 10. The selected Common ID, e.g., G.ID(P1), may be used in both the pixel request to linking server 10, and in the behavior log file transmitted to linking server 10, to facilitate matching in manners disclosed above.

Referring again to FIG. 3, report generation module 118 may be configured to generate various reports based on the linking of consumers' online behaviors and offline payment transactions. For example, report generation module 118 may generate one or more reports containing the following information:
Aggregate number of traceable individuals that made an offline purchase (verses an aggregate number of traceable individuals that did not purchase);
Break-down by source of transactions (e.g., online versus in-store versus phone, etc.);
Total sales amount of the offline transactions, and a determination of the Return on Investment (assuming costing information to be provided by the merchant or business partner); and
“Share of the Wallet” showing the average percentage of the traceable consumers spend at the merchant in relation to their total spending, including trends over time, and benchmarked against all shoppers at the merchant.

Other pertinent information may also be included in the reports.

Such reports may be presented by report generation module 118 electronically, e.g., by way of a partner web portal. Such reports may also be presented in paper form.

In an embodiment, operation of linking server 10 links a consumer's online behavior or actions to their offline (e.g. in-store or mail-order/phone-order) payment transactions, without the consumer's and/or merchant's direct involvement.

In an embodiment, operation of linking server 10 may facilitate measurement of a merchant's online advertising in contributing to offline (e.g., in-store or mail-order/phone-order) sales.

In an embodiment, operation of linking server 10 may facilitate generation of analytics reports for merchants or other clients to understand how various online behaviors and actions of consumers visiting online/mobile sites relate to their offline spending.

In an embodiment, operation of linking server 10 may facilitate targeting of online advertisements to a merchant's customers who transact with them offline.

In an embodiment, operation of linking server 10 may facilitate a low-friction omni-channel approach for merchants to provide their customers with a seamless shopping experience whether the customers are shopping online from a desktop or mobile device, by telephone or in a bricks and mortar store.

Accordingly, linking server 10 may be operated in numerous contexts and for numerous purposes, including, e.g., ad campaign effectiveness measurement, analytics for merchants or business partners, targeted advertising, etc.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer-implemented method for linking a consumer's online behavior to an offline payment transaction, the method comprising:
at, at least one processor:
generating a first mapping between an identifier of the consumer and an identifier of a payment card of the consumer;
generating a second mapping between the identifier of the consumer and an identifier of an online behavior of the consumer, in association with visiting a webpage;
receiving data reflective of an offline payment transaction, the data comprising the identifier of the payment card; and
identifying a link between the online behavior and the offline transaction by processing the generated first mapping, the generated second mapping, and the received data.

2. The method of claim 1, further comprising receiving the identifier of the consumer by way of a browser cookie.

3. The method of claim 1, further comprising receiving the identifier of the consumer by way of a Hosted Payment Page.

4. The method of claim 1, further comprising receiving the identifier of the consumer by way of an Application Programming Interface for processing an online payment transaction.

5. The method of claim 4, wherein the identifier of the consumer is received in association with an identifier of a transaction for an online payment transaction.

6. The method of claim 4, wherein the identifier of the transaction is received by way of a pixel tag.

7. The method of claim 6, wherein the pixel tag comprises an image-based pixel tag.

8. The method of claim 6, wherein the pixel tag comprises a Javascript-based pixel tag.

9. The method of claim 1, further comprising generating the identifier of the consumer.

10. The method of claim 1, further comprising receiving the identifier of the online behavior by way of a pixel tag.

11. The method of claim 1, further comprising receiving the identifier of the online behavior by way of a log file.

12. The method of claim 1, wherein the first mapping is generated in association with an online payment transaction.

13. The method of claim 1, wherein the online behavior comprises viewing an advertisement, and the identifier of the online behavior comprises an identifier of an advertising campaign.

14. The method of claim 1, further comprising: generating a report based on the link between the online behavior and the offline transaction.

15. The method of claim 1, wherein the data is received by way of a network interface.

16. A computer system for linking a consumer's online behavior to an offline payment transaction, the system comprising:
at least one processor; and
memory storing instructions, that when executed at the at least one processor, cause the system to:
generate a first mapping between an identifier of the consumer and an identifier of a payment card of the consumer;
generate a second mapping between the identifier of the consumer and an identifier of an online behavior of the consumer, in association with visiting a webpage;
receive data reflective of an offline payment transaction, the data comprising the identifier of the payment card; and
identify a link between the online behavior and the offline transaction by processing the generated first mapping, the generated second mapping, and the received data.

17. The system of claim 16, wherein the online behavior comprises viewing an advertisement, and the identifier of the online behavior comprises an identifier of an advertising campaign.

18. The system of claim 16, wherein the first mapping is generated in association with an online payment transaction.
